(19) United States
(12) Patent Application Publication
(10) Pub. No.: US 2005/0285014 A1
(43) Pub. Date: Dec. 29, 2005

(54) Method and apparatus for moulding concrete

(75) Inventor: Mark Hamilton Jardine, Dedham (GB)

Correspondence Address: BOURQUE & ASSOCIATES, P.A., 835 HANOVER STREET, SUITE 303, MANCHESTER, NH, 03104, US

(73) Assignee: Poundfield Products Limited, Needham Market (GB)

(21) Appl. No.: 10/519,616

(22) PCT Filed: Jun. 18, 2003
(86) PCT No.: PCT/GB03/02604

§ 371 Date: Aug. 12, 2005

(30) Foreign Application Priority Data
Jun. 26, 2002 (GB) 0214757.7

(51) Int. Cl. B28B 7/02

(52) U.S. Cl. 249/155

(57) ABSTRACT

The present invention relates to a method and apparatus for manufacturing a moulded concrete unit. It is particularly although not exclusively applicable to moulding of a concrete unit suitable for use as a section for a freestanding wall. The invention provides a method for moulding a concrete unit having an aperture, comprising the steps of pouring concrete into a mould having walls substantially perpendicular to a base of the mould, and including a plurality of aperture defining walls; removing at least one of said aperture defining walls once the concrete is partially set; and removing the unit from the mould once the concrete unit is sufficiently set to allow removal. The invention also provides for use in such a method.

The present invention relates to a method and apparatus for manufacturing a moulded concrete unit. It is particularly although not exclusively applicable to moulding of a concrete unit suitable for use as a section for a freestanding wall.

When storing bulk products it is often desirable to contain the product within a predetermined area. Permanent structures can be built for this purpose, but often a temporary structure is required.

Reinforced concrete units for use as a section for a free standing wall are conventionally produced in an ‘L’ shape cross section which are convenient to manufacture using a mould having a wall portion and a substantially perpendicular foot portion. However, one problem with such concrete units is that when the units are used for storage some of the product to be stored piles onto the foot portion of the unit, making subsequent handling or movement of the product inconvenient.

An improved concrete unit for use as a wall section is a unit having a base portion, a front portion and a rear portion, the front portion and rear portion extending from the base portion to form front and rear faces of the wall section in which at least one of the front and rear portions is inclined such that the distance between the front and rear faces decreases with distance away from the base portion. This results in a wall section with a triangular outer cross section. Since the centre of gravity is near to the ground, the wall section will resist tipping over.

To reduce the weight and cost, it is an advantage if the concrete unit has an aperture, for example a substantially triangular aperture, between the front and rear portions such that the wall has a, ‘A’ shape cross section.

Such an aperture provides a convenient lifting point for forklift trucks. The operator can simply slide the tines of the forklift into the hollow and lift the concrete unit without the need for lifting straps or chains.

However, a problem with producing such a concrete unit, lies in production of a mould which allows the unit to be easily removed once the concrete has set.

One way in which moulds for concrete have historically been made is such that the walls of the mould converge from the top of the mould toward the base of the mould. However, for the production of units to form a section of a freestanding wall the base of the mould forms one side of the finished unit, and the open part of the mould forms another side of the finished unit. Diverging walls should allow for easy removal of the concrete from the mould, but do not allow manufacture of a unit having sides of equal cross sectional area. Clearly this would be a desirable property for a concrete unit for use in a freestanding wall. Furthermore, when a diverging aperture defining wall is used, it is extremely difficult to remove the concrete from the mould once the concrete has set, because when the concrete in the mould is vibrated to remove any air, and during setting of the concrete pressure tends to build around the aperture defining wall, thus squeezing the wall inwards towards the aperture. If the aperture defining wall were to be removed prior to the concrete setting then the pressure described above causes the concrete to fall away from the outer walls, towards the aperture.

Conventionally, in order to manufacture concrete units for wall sections having sides with equal cross sectional area, a mould with a pivotal wall can be utilised. The pivotal wall is pivoted in order to open up the mould once the concrete is set or partially set thus allowing the concrete unit to be removed from the mould.

However, clearly there remains a problem if there is a requirement to have an aperture in the concrete unit. Whilst it is possible to utilise pivotal walls forming the exterior portion of an ‘A’ shaped concrete unit as described above, such a mechanism can not be used alone to release interior walls of the concrete unit defining an aperture.

According to the present invention there is provided a method for moulding a concrete unit having an aperture, comprising the steps of pouring concrete into a mould having walls substantially perpendicular to a base of the mould, and including a plurality of aperture defining walls; removing at least one of said aperture defining walls once the concrete is partially set; and removing the unit from the mould once the concrete unit is sufficiently set to allow removal.

It is an advantage to include the step of pivoting a second aperture defining wall about a pivotal axis adjacent said base.

To aid removal of the unit one or more external walls may be pivotable to open the mould prior to removal of the unit.

It is preferred to remove the unit by attaching a lifting plate to a first wall portion of the concrete unit using plurality of lifting sockets set in the first wall portion and which are substantially parallel to the base of the mould. The lifting plate may be attached such that the lifting plate is substantially perpendicular to the lifting sockets. Preferably the plate is attached to an external wall of the concrete unit. It is an advantage if a lifting chain is attached through a tube in a second wall portion of the concrete unit and in which the tube is substantially parallel to the base of the mould. Preferably this wall portion opposes the wall portion to which the lifting plate is attached.

According to another aspect of the invention there is provided a mould comprising a floor; a plurality of aperture defining walls substantially perpendicular to said floor; and an outer wall substantially perpendicular to said floor, wherein at least one of said aperture defining walls is removably attachable to the mould.

Preferably the outer wall is pivotally connected to the mould.

In a preferred embodiment, there are four aperture defining walls defining a quadrilateral aperture. Two opposing aperture defining walls are removably attachable to the mould, and two opposing aperture defining wall portions are pivotally connected to the mould.

Embodiments of the invention will now be described, by way of example only, with reference to the accompanying drawings, in which

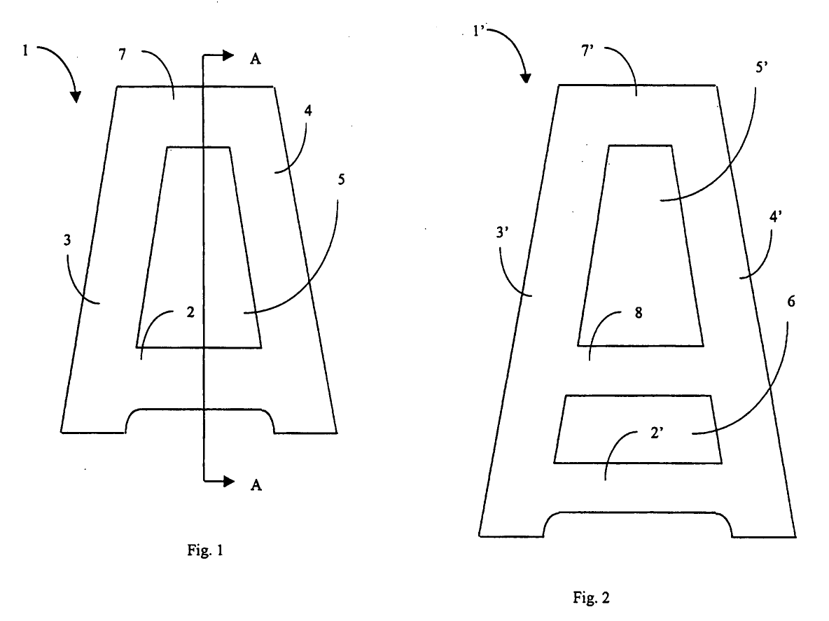

FIG. 1 illustrates vertical cross section of a concrete unit which may be manufactured according to the method of the present invention;

FIG. 2 illustrates a vertical cross section of a second concrete unit which may be manufactured according to the method of the present invention;

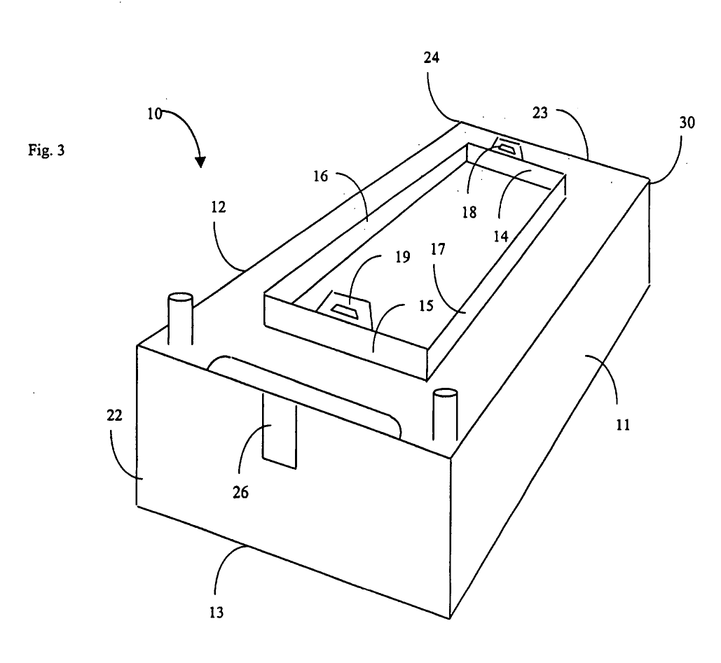

FIG. 3 illustrates schematically a perspective view of a mould according to the present invention;

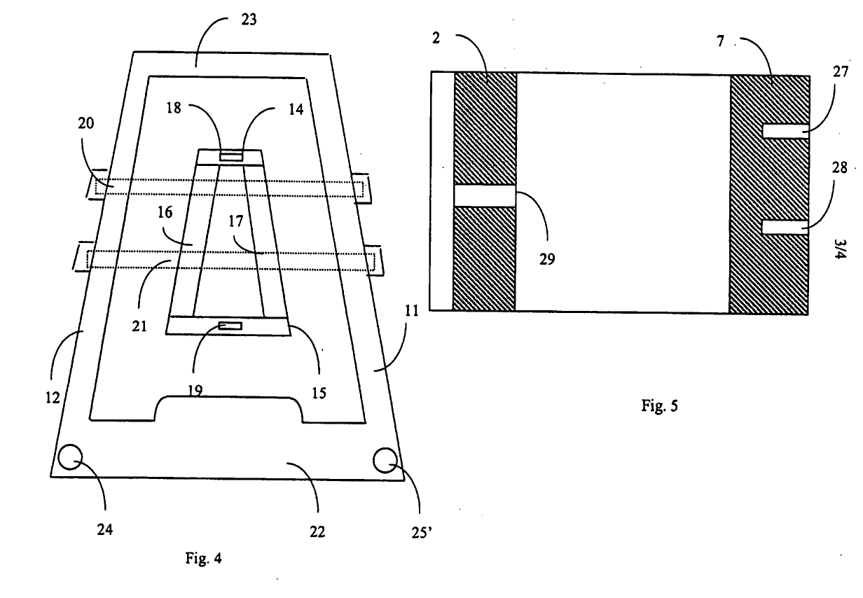

FIG. 4 illustrates schematically a top view of a mould similar to that of FIG. 3;

FIG. 5 is a cross section of the concrete unit shown in FIG. 1 at the line A-A; and

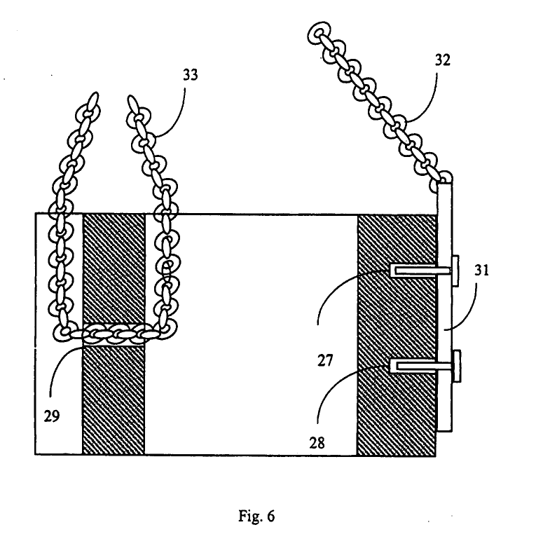

FIG. 6 is the cross section shown in FIG. 5, illustrating a preferred method of lifting the unit from a mould.

FIG. 1 illustrates a concrete unit 1, suitable for use as a section of a free standing wall, comprising a base portion 2, a front portion 3 and a rear portion 4, the front portion and rear portion extending from the base portion. The front portion 3 and the rear portion 4 are inclined and together with a top portion 7 and the base portion 2 enclose a quadrilateral aperture 5. FIG. 2 illustrates a similar concrete unit 1′, in which similar parts are numbered with a similar numeral as used in FIG. 1, and distinguished with a prime. The unit 1′ further comprises a horizontal portion 8 and a second aperture 6, and this shape would generally be used when taller wall section units are required.

FIG. 3 illustrates schematically a mould 10 according to one embodiment of the present invention, which is suitable for production of a concrete unit similar to that shown in FIG. 1.

Outer walls 11, 12, 22, 23 are perpendicular to a floor 13 of the mould, which comprises a steel base faced with a rubber. The side walls 11, 12 are pivotally connected to the bottom wall 22 of the mould. The top wall 23 is connected to the side wall 12, and walls 12, 23 may be manufactured from a continuous metal plate which is bent to form corner 24. Wall 12/23 is attachable to wall 11 at corner 30 using bolts.

Aperture defining walls 14 and 15 are perpendicular to the floor 13 of the mould. Walls 14 and 15 may be slid out from the mould by attaching a hook to brackets 18 and 19 respectively. Aperture defining walls 16, 17 are pivotally connected to the floor 13. The pivotal connection may be provided using a hinged joint, or may simply be provided by a flexible joint, as the walls 16, 17 only need to flex by about 5 mm in order to allow release of the concrete unit form the mould.

The bottom wall 22 has a removable portion 26, the purpose of which will be described later.

FIG. 4 is a schematic top view of the mould similar to that shown in FIG. 3, illustrating locking bars 20, 21 which are used to lock the pivotal walls 11, 12, 16, 17 in place whilst the mould is in use. Pivots 24, 25 extend through the bottom wall 22 and extend through the floor 13 of the mould.

FIG. 5 illustrates a section A-A through the unit shown in FIG. 1. There are threaded lifting sockets 27 and 28 in the top wall 7 of the concrete unit, and there is a tube 29 through the bottom wall 2 of the concrete unit. The lifting sockets 27, 28 are suitable for use with a 10 cm long 16 mm bolt. The end of each of the lifting sockets 27, 28 which is internal to the concrete unit is attached to a reinforcing cage (not shown) which is used to strengthen the concrete unit. For example there may be a hole formed in the end of a lifting socket which is hooked onto a suitably formed portion of the reinforcing cage. The internal end may be flattened, or may be closed using a bung to prevent concrete from leaking into the socket during manufacture.

A concrete unit is manufactured as follows. Pivotal walls 16 and 17 are placed in an upright position, pivotal walls 12/23 and 11 are closed and bolted together at corner 30. Removable walls 14 and 15 are slid into position so that the mould is as illustrated in FIG. 3. Internal faces of the mould walls are coated with release oil to aid removal of the unit once the concrete has set.

A reinforcing cage, together with lifting sockets 27, 28 and tube 29 are inserted into the mould 10, and locking bars 20, 21 are then locked into place to maintain the position of the pivotal walls.

Concrete is poured into the mould. The concrete is then vibrated, for example using a conventional poker vibrator, so that any trapped air rises to the surface of the mould. Once the concrete has settled, but before the concrete has set substantially (usually between one and two hours) walls 15 and 16 are removed. Portion 26 may also be removed once the concrete has settled, although the portion 26 may equally well be removed immediately prior to releasing the unit from the mould.

Once the concrete is sufficiently set to allow removal of the unit from the mould the locking bars 20 and 21 are removed. Pivotal walls 16, 17 are pivoted away from the internal aperture wall, and pivotal wall 12/23 is unbolted from side wall 11. The mould is then opened by pivoting walls 11, 12 about pivots 24, 25 respectively.

It is possible to remove the unit from the mould after less than 24 hours due to the use of horizontal lifting sockets together with a lifting plate, which will now be described with reference to FIG. 6.

Once pivotal walls 11/24 and 12 have been opened. Lifting sockets 27 and 28 are exposed. A lifting plate is attached to the lifting sockets 27, 28 using 10 cm long 16 mm bolts. A chain 32 is attached to the upper end of the lifting plate 31. A second chain 33 is threaded through the tube 29, and the portion 26 is removed from the wall 22, if not done previously. The concrete unit may then be lifted away from the mould 10. The combination of the horizontally positioned lifting sockets 27, the lifting plate 31 secured perpendicular to the lifting sockets and the chain 33 attached through the opposing wall 5, means that when the unit is lifted the concrete is compressed, and therefore the unit may be removed sooner than using conventional means which require the concrete to be substantially set (usually after about 48 hours).

Clearly it is a major advantage if units can be removed earlier from a mould as the mould may then be reused to produce another unit sooner, and the plant requirement to meet a particular unit production rate is reduced.

The units are then placed elsewhere whilst the concrete fully hardens, usually for about one week.

1. A method for moulding a concrete unit having an aperture, comprising the steps of
pouring concrete into a mould having walls substantially perpendicular to a base of the mould, and including a plurality of aperture defining walls;
removing one of said aperture defining walls once the concrete is partially set; and
removing the unit from the mould once the concrete unit is sufficiently set to allow removal.

2. A method according to claim 1, further comprising the step of pivoting a second aperture defining wall about a pivotal axis adjacent said base.

3. A method according to claim 1 or claim 2, further comprising the step of pivoting an external wall to open the mould prior to removal of the unit.

4. A method according to claim 1 any one of the preceding claims, in which removing the unit comprises the step of attaching a lifting plate to a first wall portion of the concrete unit using plurality of lifting sockets set in the first wall portion and which are substantially parallel to the base of the mould.

5. A method according to claim 4, in which the lifting plate is attached such that the lifting plate is substantially perpendicular to the lifting sockets, and said first wall portion is an external wall of the concrete unit.

6. A method according to claim 4 or claim 5, in which removing the unit further comprises the step of attaching a lifting chain to a bore through a second wall portion of the concrete unit and in which the bore is substantially parallel to the base of the mould.

7. A method according to claim 6, in which the second wall portion opposes said first wall portion.

8. A mould comprising a base; a plurality of aperture defining walls substantially perpendicular to said base; and
an outer wall substantially perpendicular to said floor, wherein the aperture defining wall is removably attachable to the mould.

9. A mould according to claim 8 in which the outer wall is pivotally connected to the mould.

10. A mould according claim 8, in which at least one of said aperture defining walls is pivotally connected to the base.

11. A mould according to claim 8, comprising four aperture defining walls defining a quadrilateral aperture, and in which two opposing aperture defining walls are removably attachable to the mould, and in which two opposing aperture defining wall portions are pivotally connected to the base.
